(19) United States
(12) Patent Application Publication
(10) Pub. No.: US 2021/0071722 A1
(43) Pub. Date: Mar. 11, 2021

(54) ROTATION TRANSMISSION DEVICE

(71) Applicant: NTN Corporation, Osaka (JP)

(72) Inventors: Koji SATO, Shizuoka (JP); Shintaro ISHIKAWA, Shizuoka (JP); Masamichi FUJIKAWA, Shizuoka (JP)

(73) Assignee: NTN Corporation, Osaka (JP)

(21) Appl. No.: 16/959,482

(22) PCT Filed: Dec. 27, 2018
(86) PCT No.: PCT/JP2018/048074

§ 371 Date: Jul. 1, 2020

(30) Foreign Application Priority Data
Jan. 5, 2018 (JP) 2018-000600

(51) Int. Cl. F16D 41/08; F16D 27/118

(52) U.S. Cl. CPC F16D 41/088; F16D 41/105; F16D 27/118

(57) ABSTRACT

A rotation transmission device is provided which includes, in its housing, an electromagnetic clutch, and a two-way clutch by which a first shaft and a second shaft are selectively engaged with, and disengaged from, each other. A rolling bearing is disposed at one axial end of the housing, and supports the second shaft and the housing. Locking arrangements prevent relative axial movement between the second shaft and the rolling bearing, and between the rolling bearing and the housing. A movement restricting arrangement is disposed at the other axial end of the housing, and restricting movement of the electromagnetic clutch toward the other axial end of the housing.

### TECHNICAL FIELD

The present invention relates to a rotation transmission device capable of selectively performing and stopping the transmission of rotation.

### BACKGROUND ART

As rotation transmission devices that selectively perform and stop the transmission of the rotation of a driving shaft to a driven shaft, rotation transmission devices are known which include a two-way clutch that is selectively engaged and disengaged by an electromagnetic clutch.

For example, the below-identified Patent Document 1 discloses a rotation transmission device including a control cage and a rotary cage which are mounted between an outer ring and an inner ring disposed inside of the outer ring with pillars of the control cage circumferentially alternating with pillars of the rotary cage. Opposed pairs of rollers are received in respective pockets defined between the adjacent ones of the pillars of the control cage and the pillars of the rotary cage. Elastic members are each received between a respective opposed pair of rollers to bias the opposed pair of rollers away from each other to a standby position at which the opposed pair of rollers can engage with a cylindrical surface formed on the inner periphery of the outer ring and one of cam surfaces formed on the outer periphery of the inner ring. Thus, when the inner ring rotates in one direction, one of each opposed pair of rollers engages with the cylindrical surface of the outer ring and the cam surface, thereby transmitting the rotation of the inner ring to the outer ring.

A flange of the control cage and a flange of the rotary cage are supported by a slide guide surface formed on the outer periphery of an input shaft so as to be axially slidable along the slide guide surface. A thrust bearing is disposed between the flange of the rotary cage part and a support ring fitted on the input shaft. A torque earn is disposed between the flange of the control cage and the flange of the rotary cage. The torque cam includes opposed pairs of cam grooves formed in the opposed surfaces of the flange of the control cage and the flange of the rotary cage; and balls each received in a respective opposed pair of cam grooves. Each cam groove is deepest at its circumferential center, and its depth gradually decreases toward its respective circumferential ends.

An electromagnetic clutch is disposed on the input shaft connected to the inner ring. The control cage is fixedly coupled to an armature opposed to the rotor of the electromagnetic clutch.

When the electromagnetic coil of the electromagnetic clutch is energized with the two-way clutch of the device engaged, an attraction force is applied to the armature opposed to the rotor of the electromagnetic clutch, so that the armature axially moves until the armature is attracted to the rotor. As the armature axially moves in this direction, the control cage moves in the direction in which the flange of the control cage part approaches the flange of the rotary cage part. As a result, each ball of the torque cam moves toward the deepest positions of the opposed pair of cam grooves, and the control cage and the rotary cage rotate relative to each other in the direction in which the circumferential widths of the respective pockets decrease. Due to this relative rotation, each opposed pair of rollers are pushed and moved by the corresponding pillars of the control, and rotary cages toward a neutral position, and are disengaged from the cylindrical surface of the outer ring and the cam surfaces of the inner ring, so that the rotation of the inner ring is not transmitted to the outer ring, in other words, the inner ring rotates freely/alone.

With the inner ring rotating alone, when the electromagnetic coil is de-energized, the attraction force applied to the armature disappears, and thus the armature becomes rotatable. As a result, due to the pressing forces of the elastic members, the control cage and the rotary cage rotate relative to each other in the direction in which the circumferential widths of the respective pockets increase. Due to this relative rotation, the opposed pairs of rollers move to the standby position at which the opposed pairs of rollers can engage with the cylindrical surface of the outer ring and the cam surfaces of the inner ring, and thus the rotation of the inner ring can be transmitted to the outer ring through one of each opposed pair of rollers.

### PRIOR ART DOCUMENT(S)

### Patent Document(s)

Patent document 1: Japanese Unexamined Patent Application Publication No. 2014-40912

### SUMMARY OF THE INVENTION

### Problems to be Solved by the Invention

Patent Document 1 discloses a rotation transmission device including an elastic member (e.g., a wave spring) mounted in a bearing tube disposed at one end of its housing so that the built-in components including the two-way clutch and the electromagnetic clutch are kept stable in the axial direction. The elastic member biases the built-in components toward a snap ring disposed on the inner periphery of the other end of the housing. This eliminates the need, as has been necessary heretofore, to select and mount a suitable shim in order to keep the built-in components stable, and thus makes it possible to assemble the rotation transmission device easily at a reduced cost.

The axial dimension of such an elastic member for keeping the built-in components stable when set in position (set spring height) is normally determined by the axial dimension of the housing between the portion of the housing where the snap ring engages and the portion of the housing where the elastic member engages; the axial thickness of the snap ring; and the axial dimension of the built-in components (subassembly dimension, namely the axial dimension between the abutment surfaces of the subassembly which abut against the snap ring and the elastic member, respectively). Therefore, due, to the respective tolerances thereof, the dimension of the set spring height tends to vary within a wide range, which results in a large variation in the magnitude of the spring load when the spring is set in position.

Also, in order to prevent the built-in components from moving relative to the housing and the snap ring due to vibration, the minimum load applied to the elastic member (i.e., the load applied to the elastic member when set in position) needs to be adjusted to a predetermined value or more.

However, if, the minimum load to the elastic member is increased, the maximum load applied to the elastic member, e.g., at the time of vibration will also increase. As a result, an unnecessary axial load will be applied to support bearings which support an input shaft and, an output shaft, and this may decrease the service lives of the support bearings. Also, when the elastic member receives a force that tends to pull the outer ring from the outside of the housing (For example, if the rotation transmission device is used as a steering device, this force is a reaction force applied to the rotation transmission device from the wheel), the elastic member may be crushed.

It is an object, of the present invention to prevent built-in components including the two-way clutch and the electromagnetic clutch from becoming axially unstable in the housing regardless of the load conditions.

### Means for Solving the Problems

In order to achieve the above object, the present invention provides a rotation transmission device comprising: a two-way clutch received in a housing and configured such that a first shaft and a second shaft arranged coaxially with each other are selectively engaged with and disengaged, from each other by the two-way clutch; and an electromagnetic clutch received in the housing and including an electromagnet, the electromagnetic clutch being configured to selectively engage and disengage the two-way clutch by energizing and de-energizing the electromagnet; wherein the two-way clutch comprises: inner member disposed on one of the first shaft and the second shaft; an outer member disposed on the other of the first shaft and the second shaft; engaging elements disposed between the inner member and the outer member; and a cage retaining the engaging elements, and wherein, the rotation transmission device further comprises: a rolling bearing disposed at one axial end of the housing, and rotatably supporting the second shaft and the housing; locking means that prevent relative axial movement between the second shaft and the rolling bearing, and between the rolling bearing and the housing; and a movement restricting means disposed at the other axial end of the housing, and restricting movement of the electromagnetic clutch in a direction from the one to the other axial end of the housing.

The housing may comprise: a tubular portion in which the two-way clutch and the electromagnetic clutch are received; and a hearing tube located between the one axial end of the housing and the tubular portion, and having a smaller diameter than the tubular portion. The rolling bearing may be disposed in the bearing tube. The locking means may include first locking means and second locking means, the first locking means comprising: a first bearing snap ring disposed on an inner periphery of the bearing tube so as to retain the one axial end of the rolling bearing; and a second hearing snap ring disposed on an outer periphery of the second shaft so as to retain the one axial end of the rolling bearing.

The second locking means may comprise: a protrusion disposed on the inner periphery of the bearing tube so as to retain the other axial end of the rolling bearing; and a step disposed on the outer periphery of the second shaft so as to retain the other axial end of the rolling hearing.

The movement restricting means may include a movement restricting snap ring disposed on an inner periphery of the housing at the other axial end of the housing.

The movement restricting means may include an elastic member for movement restriction engaged with an inner periphery of the housing at the other axial end of the housing, and biasing the electromagnetic clutch in a direction from the other to the one axial end of the housing.

The movement restricting means may include: a movement restricting snap ring disposed on an inner periphery of the housing at the other axial end of the housing; and an elastic member for movement restriction disposed between the movement restricting snap ring and the electromagnetic clutch, and biasing the electromagnetic clutch in a direction from the other to the one axial end of the housing.

### Effects of the Invention

The rotation transmission device of the present invention includes (i) locking means configured to axially immovably fix a rolling bearing disposed at one axial end of the housing and rotatably supporting the second shaft and the housing, the second shaft and the rolling bearing, and the rolling bearing and the housing; and (ii) a movement, restricting means disposed at the other axial end the housing, and configured to restrict the movement of the electromagnetic clutch to the other axial end of the housing. Therefore, it is possible to prevent the bunt in components, including the two-way clutch and the electromagnetic clutch from becoming axially unstable in the housing regardless of the load conditions.

### BRIEF DESCRIPTION OF THE DRAWINGS

FIG. 1 is a vertical sectional view of a rotation transmission device embodying the present invention.

FIG. 2 is a sectional view taken along line II-II of FIG. 1.

FIG. 3 is an enlarged view of a portion of FIG. 2.

FIG. 4 is a sectional view taken along line IV-IV of FIG. 1.

FIG. 5 is a sectional view taken along line V-V of FIG. 4.

FIG. 6 is a sectional view taken along line VI-VI of FIG. 1.

FIG. 7A is a sectional view taken along line of FIG. 6.

FIG. 7B is a sectional view taken along line VII-VII of FIG. 6.

FIG. 8 is an enlarged view of one axial end of the device of FIG. 1.

FIG. 9 is an enlarged view of the other axial end of the device of FIG. 1.

FIG. 10 is an enlarged view showing a variation of FIG. 9.

### BEST MODE FOR CARRYING OUT THE INVENTION

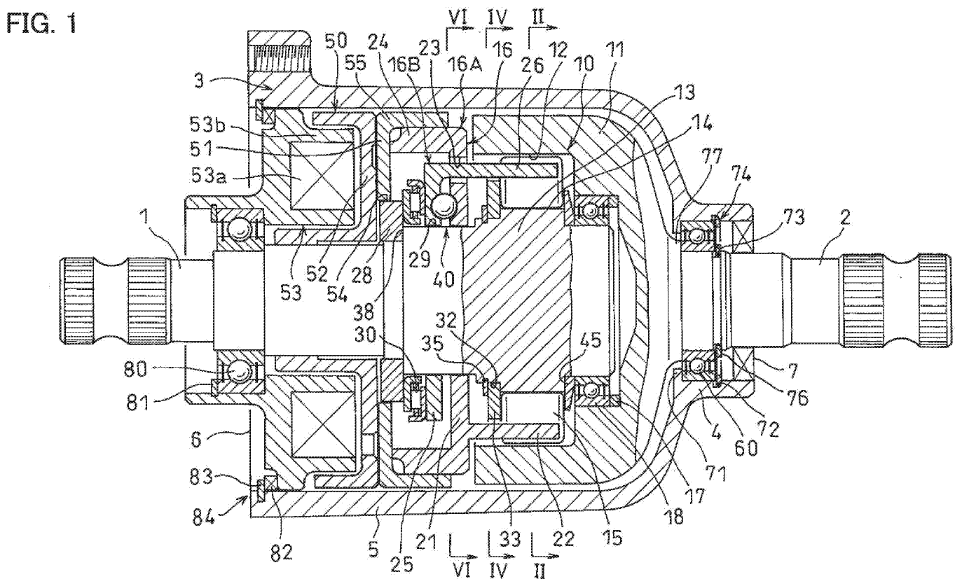

The rotation transmission device embodying the present invention is now described with reference to the drawings. As illustrated in FIG. 1, the rotation transmission device includes a first shaft, 1; a second shaft 2 arranged coaxially with the first shaft 1; a housing 3 covering end portions of the first shaft 1 and the second shaft 2; a two-way clutch 10 mounted in the housing 3 and configured to selectively perform and stop the transmission of rotation between the first shaft 1 and the second shaft 2; and an electromagnetic clutch 50 configured to selectively engage and disengage the two-way clutch 10.

The housing 3 includes a tubular portion 5 in which the two-way clutch 10 and the electromagnetic clutch 50 are received; and a bearing tube 4 located between one axial end of the housing 3 and the tubular portion 5, and having a smaller diameter than the tubular portion 5. A sealed rolling bearing 60 is disposed in the bearing tube 4, and supports the second shaft 2 such that the second shaft 2 is rotatable relative to the bearing tube 4.

The two-way clutch 10 includes an inner member 13 disposed on the first shaft 1; an outer member 11 disposed on the second shaft 2; rollers 15 mounted between the inner member 13 and the outer member 11; and a cage 16 retaining the rollers 15.

The outer member 11 is an annular member disposed on the end portion of the second shaft 2, and having a cylindrical surface 12 on its inner periphery. The inner member 13 is a shaft-shaped or annular-shaped member disposed on the end portion of the first shaft 1, and having a plurality of circumferentially aligned cam surfaces 14 on its outer periphery.

The rollers 15 as engaging elements are arranged in opposed pairs, and each opposed pair of rollers 15 and an elastic member 20 are mounted between the corresponding cam surface 14 and the cylindrical, surface 12 with the elastic member 20 disposed between the opposed pair of rollers 15. The opposed pairs of rollers 15 are retained by the cage 16.

When the inner member 13 rotates in one direction around its center axis, the rotation is transmitted to the outer member 11 by engaging one of each, opposed pair of rollers 15 with the cylindrical surface 12 and the corresponding cam surface 14. When the inner member 11 rotates in the other direction around its center axis, the rotation is transmitted to the outer member 11 by engaging the other of each opposed pair of rollers 15 with the cylindrical surface 12 and the corresponding cam surface 14.

The outer member 11 is closed at the one axial end thereof, and a small-diameter recess 17 is formed in the inner surface of this closed one axial end. A bearing 18 is disposed in the small-diameter recess 17, and rotatably supports the end portion of the first shaft 1.

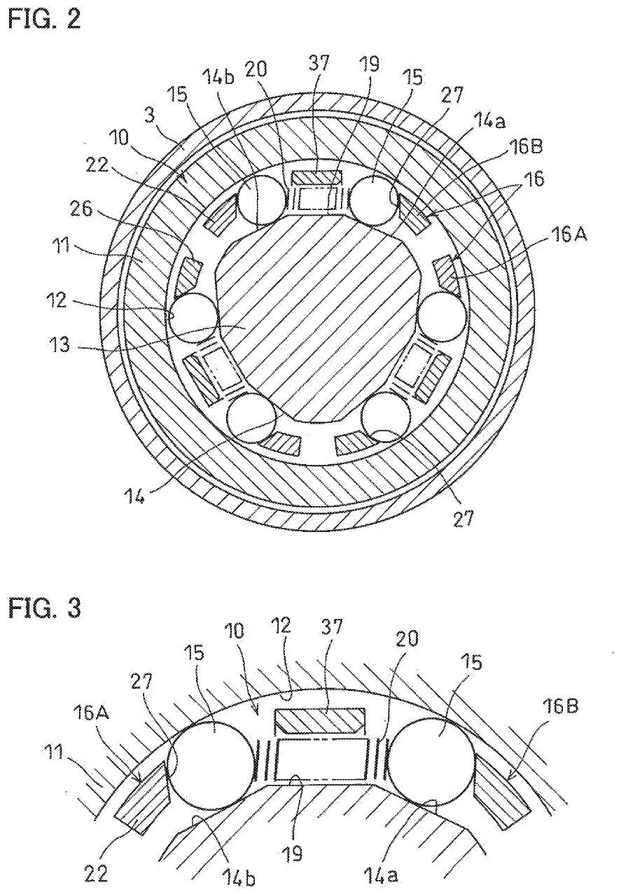

In the embodiment, the inner member 13 is integral with the first shaft 1. As illustrated in FIG. 2, each cam surface 14 on the outer periphery of the inner member 13 includes a pair of inclined surface portions 14a and 14b inclined in opposite directions to each other so as to define, between the respective inclined surface portions 14a and 14b and the cylindrical surface 12 of the outer member 11, a pair of wedge-shaped spaces each narrowing toward its circumferential end that is circumferentially farthest from the other of the pair of wedge-shaped spaces. Between the inclined surface portions 14a and 14b of the respective cam surfaces 14, flat, elastic member supporting surface portions 19 extends in the tangential directions of an imaginary circle around the center axis of the inner member 13, and support the respective elastic members 20.

The elastic members 20 are coil springs in the embodiment, and are each mounted between a respective opposed pair of the rollers 15 so as to bias and push the pair of rollers 15 away from each other, as illustrated in FIGS. 2 and 3, thereby keeping the pair of rollers at a standby position at which the pair of rollers 15 can engage with the cylindrical surface 12 and the cam surface 14.

The cage 16 is constituted by a control cage part 16A and a rotary cage part 16B. The control cage part 16A includes an annular flange 21, and pillars 22 equal in number to the cam surfaces 14, and extending from an outer peripheral portion of one surface of the annular flange 21 so as to be circumferentially equidistantly spaced apart from each other. The control cage part 16A is formed with circular arc-shaped elongated holes 23 between the respective circumferentially adjacent pairs of pillars 22. The control cage part 16A further includes a tubular portion 24 extending from the outer periphery thereof in the direction opposite to the direction in which the pillars 22 extend. The rotary cage part 16B includes an annular flange 25, and pillars 26 equal in number to the cam surfaces 14, and extending from the outer periphery of the annular flange 25 so as to be circumferentially spaced apart from each other.

The control cage part 18A and the rotary cage part 166 are combined together such that the pillars 26 of the rotary cage part 16B are inserted through the respective elongated holes 23 of the control cage part 16A so that the pillars 22 circumferentially alternate with the pillars 26. With the cage parts combined together in this way, the cage 16 is mounted in position such that the distal end portions of the pillars 22 and 26 are disposed between the outer member 11 and the inner member 13, and the flange 21 of the control cage part 16A and the flange 25 of the rotary cage part 16B are located between the outer member 11 and a support ring 28 fitted on the outer periphery of the first shaft 1.

With the control and rotary cage parts 16A and 16B mounted in position as described above, as illustrated in FIGS. 2 and 3, pockets 27 are defined between the pillars 22 of the control cage part 16A and the co ding pillars 26 of the rotary cage part 16B so as to be radially opposed to the corresponding cam surfaces 14 of the inner member 13, and one opposed pair of the rollers 15 and one of the elastic members 20 are received in each pocket 27.

As illustrated its FIG. 1, the flange 21 of the control cage part 16A and the flange 25 of the rotary cage part 16B are supported by a slide guide surface 29 formed on the outer periphery of the first shaft 1 so as to he slidable along the slide guide surface 29. A thrust bearing 30 is mounted between the flange 25 of the rotary cage part 16B and the support ring 28 fitted on the first shaft 1. The thrust bearing 30 supports the rotary cage part 16B such that rotary cage part 16B is rotatable relative to the first shaft 1, while preventing the rotary cage part 16B from moving toward the electromagnetic clutch 50.

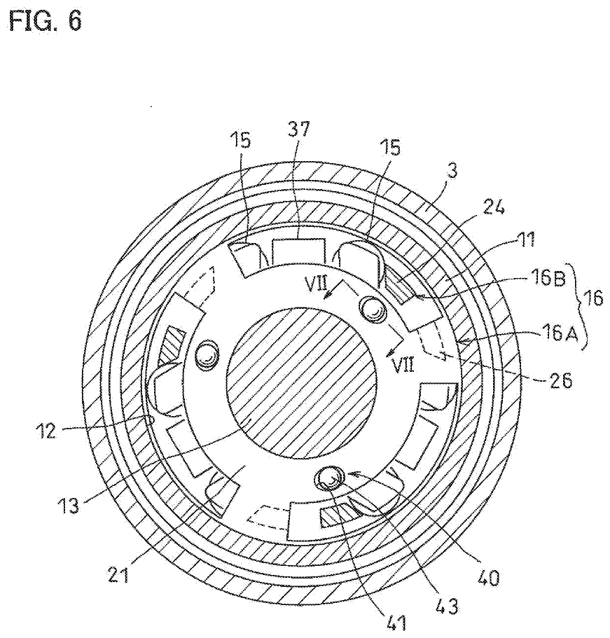

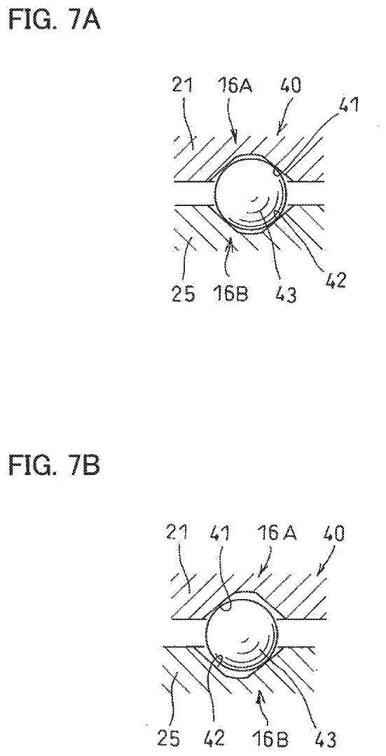

A torque cam 40 is disposed between the flange 21 of the control cage part 16A and the flange 25 of the rotary cage part 16B. As illustrated in FIGS. 6, 7A and 7B, the torque cam 40 includes opposed pairs of cam grooves 41 and 42 disposed in the respective opposed surfaces of the flange 21 of the control cage part 16A and the flange 25 of the rotary cage part 16B. Each cam groove 41, 42 is deepest at the circumferential center of the cam groove, and the depth of the cam groove gradually decreases toward the respective circumferential ends of the cam groove. The torque cam 40 further includes balk 43 each received between one circumferential end portion of a respective cam grooves 41 and the opposite circumferential end portion of the corresponding cam groovy 42.

The torque cam 40 is configured such that, when the control cage part 16A moves in the axial direction in which the flange 21 of the control cage part 16A approaches the flange 25 of the rotary cage part 16E, as illustrated in FIG. 7A, the balls 43 roll and move toward the deepest portions of the respective opposed pairs of cam grooves 41 and 42, thereby rotating the control cage part 16A and the rotary cage part 16B relative to each other in the direction in which the circumferential widths of the respective pockets 27 decrease.

At the intersection between the slide guide surface 29 and an axial end surface of the inner member 13 at the other axial end thereof, a cylindrical, holder fitting surface 32 having a larger diameter than the slide guide surface 29 is formed. A spring holder 33 is fitted on the holder fitting surface 32. The spring holder 33 is rotationally fixed relative to the first shaft 1, and is sandwiched and axially immovably supported by a snap ring 35 attached to the holder fitting surface 32, and the axial end surface of the inner member 13.

The spring holder 33 includes, on its outer periphery, positioning pieces 36 disposed in the respective pockets 27 of the cage 16. The positioning pieces 36 are configured to receive, on the respective circumferentially opposite side edges thereof, the pillars 22 of the control cage part 16A and the pillars 26 of the rotary cage part 16B so as to keep the opposed pairs of rollers 15 in their neutral position. The positioning pieces 36 also prevent the rollers 15 from moving in the direction from the one to the other axial end of the inner member 13. As illustrated in FIG. 5, each positioning piece 36 is provided with a spring supporting piece 37 for preventing radially outward movement of the elastic member 20.

A washer 45 is fitted on the one axial end of the first shaft 1. The washer 45 is in abutment with, and retained by, an end surface of a step on the one axial end of the inner member 13, and the bearing 18 on the one axial end of the first shaft 1, and prevents the rollers 15 from moving in the direction from the other to the one axial end of the inner member 13.

The electromagnetic clutch 50 includes an armature 51 axially opposed to the end surface of the tubular portion 24 of the control cage part 16A; a rotor 52 axially opposed to the armature 51; and an electromagnet 53 axially opposed to the rotor 52.

The armature 51 is fitted on a cylindrical radially outer surface 54 of the support ring 28, and is rotatably and axially slidably supported by the support ring 28. The armature 51 includes, at its outer peripheral portion, a coupling tube 55 having a radially inner surface into which the tubular portion 24 of the control cage part 16A is press-fitted so that the control cage part 16A and the armature 51 are fixedly coupled to each other. Due to this coupling, the armature 51 is axially slidably supported by two axially separated portions, i.e., by the cylindrical radially outer surface 54 of the support ring 28 and the slide guide surface 29 on the outer periphery of the first shaft 1.

The support ring 28 is axially positioned by a step 38 formed on the other axial end of the slide guide surface 29 of the first shaft 1. A shim may be disposed between the support ring 28 and the rotor 52 so as to axially position the rotor 52. The support ring 28 is made of a non-magnetic material such as a non-magnetic metal or a resin.

The two-way clutch 10 is selectively engaged and disengaged by energizing and de energizing the electromagnet 53 of the electromagnetic clutch 50, thereby rotating the control cage part 16A and the rotary cage part 16B relative to each other.

The electromagnet 53 includes an electromagnetic coil 53a and a core 53b supporting the electromagnetic coil 53a. The core 53b is fitted in the opening 6 of the housing 3 at the other end thereof. A movement restricting means 84 is disposed in the opening 6 of the housing 3 at the other end thereof to not only prevent separation of the core 53b but also restrict movement of the, core 53b in the direction from the one to the other axial end of the housing. In other words, the movement restricting means 84 is disposed at the other axial end of the housing 3, and functions to restrict the movement of the electromagnetic clutch 50 in the direction from the one to the other axial end of the housing 3. The core 53a is rotatable relative to the first shaft 1 through a bearing 80 fitted on the first shaft 1. A snap ring 81 prevents separation of the hearing 80 from the housing 3.

In the bearing tube 4, a seal member 7 is mounted between the roiling bearing 60 and the one axial end of the bearing tube 4 to seal a gap between the bearing tube 4 and the outer periphery of the second shaft 2. The rotation transmission device includes, in its bearing tube 4, locking means 74, 76, 71 and 77 that prevent relative axial movement between the second shaft 2 and the rolling bearing 60, and between the roiling bearing 60 and the housing 3. The second shaft 2, the rolling bearing 60 and the housing 3 are thus axially immovably supported by the locking means 74, 76, 71 and 77.

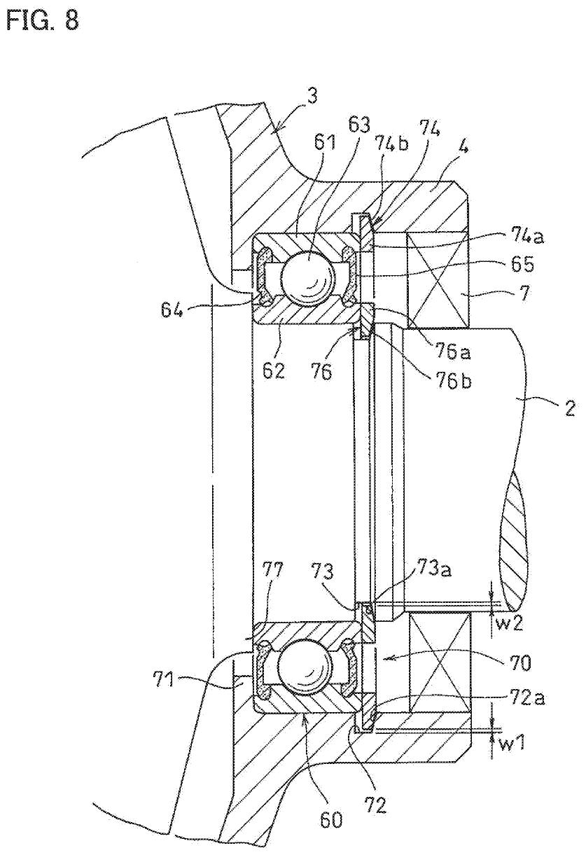

In the embodiment, as illustrated in FIG. 8, the rolling bearing 60 is a deep groove ball bearing including balls 63 as rolling elements disposed between an outer ring 61 and an inner ring 62. The two axial sides of the bearing space between the outer ring 61 and the inner ring 62 are sealed by seals 64 and 65, respectively.

The locking means 74 and 76, which are disposed adjacent to the one axial end of the rolling bearing 60, are constituted, respectively, by a first bearing snap ring 74 disposed on the inner periphery of the bearing tube 4 so as to retain the one axial end of the outer ring 61 of the rolling bearing 60; and a second bearing snap ring 76 disposed on the outer periphery of the second shaft 2 so as to retain the one axial end of the inner ring 62 of the rolling bearing 60.

The locking means 71 and 77, which are disposed adjacent to the other axial end of the rolling bearing 60, are constituted, respectively, by a protrusion 71 on the inner periphery of the bearing tube 4 so as to retain the other axial end of the outer ring 61 of the rolling bearing 60; and a step 77 on the outer periphery of the second shaft 2 so as to retain the other axial end of the inner ring 62 of the rolling bearing 60.

It is now described how the rotation transmission device embodying the present invention operates. In the embodiment, rotation is inputted to the first shaft 1, and outputted from the second shaft 2.

With the electromagnetic coil 53a of the electromagnetic clutch 50 de-energized, the rollers 15 of the two-way clutch 10 are in a position where they can engage with the cylindrical surface 12 of the outer member 11 and the respective cam surfaces 14 of the inner member 13. Therefore, when the first shaft 1 rotates in one direction around its center axis, this rotation is transmitted from the inner member 13 to the outer member 11 through one of each opposed pair of rollers 15, so that the second shaft 2 rotates in the same direction as the first shaft 1. Likewise, when the first shaft 1 rotates in the other direction around its center axis, this rotation is transmitted to the second shaft 2 through the other of each opposed pair of rollers 15, so that the second shaft 2 rotates in the same direction, as the first shaft 1

With the two-way clutch 10 engaged, when the electromagnetic coil 53a of the electromagnetic clutch 50 is energized, an attraction force is applied to the armature 51, so that the armature 51 axially moves until the armature 51 is attracted to the rotor 52 as illustrated in FIG. 1. When the armature 51 axially moves toward the rotor 52 since the armature 51 and the control cage part 16A are fixedly coupled to each other due to the fitting of the tubular portion 24 and the coupling tube 56, the control cage part 16A moves in the direction in which the flange 21 of the control cage part 16A approaches the flange 25 of the rotary cage part 16B.

Due to this relative movement, of the control cage part 16A and the rotary cage part 16B, the balls 43 of the torque cam 40 roll and move toward the deepest portions of the opposed pairs of cam grooves 41 and 42 as illustrated in FIG. 7A, so that the control cage part 16A and the rotary cage part 16B rotate relative to each other in the direction in which the circumferential widths of the respective pockets 27 decrease. Due to this relative rotation of the control cage part 16A and the rotary cage part 16B, each opposed pair of rollers 15 are pushed, and moved by the pillar 22 of the control cage part 16A and the pillar 26 of the rotary cage part 16B, respectively, toward the neutral position illustrated in FIG. 2.

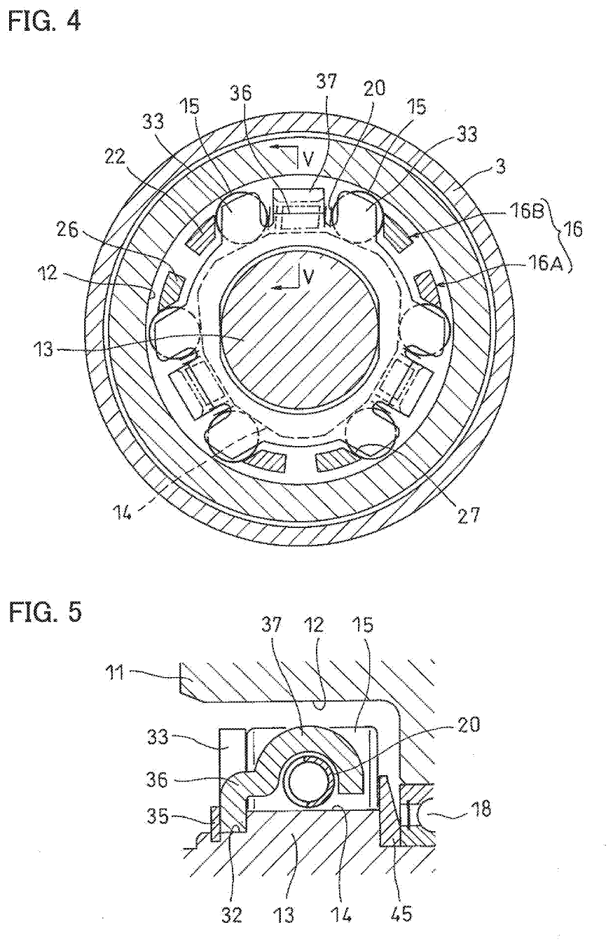

When, with the pairs of rollers 15 disengaged from the cylindrical surface 12 and the cam surfaces 14, the control cage part 16A and the rotary cage part 16B further rotate relative to each other in the direction in which the circumferential widths of the respective pockets 27 decrease, the pillars 22 of the control cage part 16A and the pillars 26 of the rotary cage part 16B abut against the respective opposite side edges of the positioning pieces 36 of the spring holder 33 illustrated in FIG. 4. This stops the relative rotation between the control cage part 16A and the rotary cage part 16B with the pairs of rollers 15 disengaged. Therefore, when the first shaft 1 rotates in this state, this rotation is not transmitted to the second shaft 2, and the first shaft 1 rotates freely/alone.

With the first shaft 1 rotating alone, when the electromagnetic coil 53a is de-energized, the attraction force applied to the armature 51 disappears, and thus the armature 51 becomes rotatable. As a result, due to the pressing forces of the elastic members 20, the control cage part 16A and the rotary cage part 16B rotate relative to each other in the direction in which the circumferential widths of the respective pockets 27 increase. Due to this relative rotation, the rollers 15 move to the standby position at which the rollers 15 can engage with the cylindrical surface 12 and the cam surfaces 14, and thus rotation, in one direction is transmitted between the inner member 13 and the outer member 11 through one of each opposed pair of rollers 15. In this state, when the first shaft 1 is stopped and then rotated in the other direction, the rotation of the inner member 13 is transmitted to the outer member 11 through the other of each opposed pair of the rollers 15. At this time, when the control cage part 16A and the rotary cage part 16B rotate relative to each other in the direction in which the circumferential widths of the respective pockets 27 increase, the bans 43 of the torque cam 40 roll and move toward shallow portions of the opposed pairs of cam grooves 41 and 42 as illustrated in FIG. 7B.

According to the present invention, at the one axial end of the housing 3, the second shaft 2, the rolling bearing 60 and the housing 3 are axially immovably supported by the locking means 74, 76, 71 and 77, whereas, at the other axial end of the housing 3, the movement restricting means 84 restricts movement of the electromagnetic clutch 50 in the direction from the one to the other axial end of the housing 3y. Therefore, when the components built into the housing 3, including the two-way clutch 10 and the electromagnetic clutch 50, vibrate relative to the housing 3, the support load applied to the housing 3 due to this vibration is small. This allows simplification of the support structure for the built-in components including the two-way clutch 10 and the electromagnetic clutch 50.

Also, even when a reaction force from the second shaft 2 (external force in the direction in which the second shaft 2 is pulled out of the housing 3) is applied to the outer member 11, since the outer member 11 is fixed to be axially unmovable relative to the housing 3 by the rolling bearing 60 and the movement restricting means 84, no load is applied to other components, thus enabling the rotation transmission device to operate reliably.

In the embodiment, as described above and illustrated in FIG. 8, the locking means 74 and 76 adjacent to the one axial end of the rolling bearing 60 are constituted, respectively, by the first bearing snap ring 74 on the inner periphery of the bearing tube 4, and the second bearing snap ring 76 on the outer periphery of the second shaft 2, whereas the locking means 71 and 77 adjacent to the other axial end of the rolling bearing 60 are constituted, respectively, by the protrusion 71 on the inner periphery of the bearing tube 4, and the step 77 on the outer periphery of the second shaft 2.

Since, in the deep end portion of the interior of the bearing tube 4, a protrusion, such as the protrusion 71, that is integral with the housing 3, and a step, such as the step 77, that is integral with the second shaft 2, are used as means for restricting movement of the rolling nearing 60 in the direction from the one to the other axial end of the housing 3, such locking means can be formed simultaneously when forming the housing 3 and the second shaft 2, respectively. Also, since the space of the bearing tube 4 in the deep end portion of its interior is small, it is easier to integrally form the locking means 71 and 77 on the housing 3 and the second shaft 2, respectively, than to attach, as the locking means 71 and 77, separate members such as snap rings onto the inner periphery of the housing 3 and the outer periphery of the second shaft 2, respectively.

In the embodiment, the protrusion 71 is a flange extending around the entire inner circumference of the bearing tube 4, and the step 77 is a shoulder extending around the entire outer circumference of the second shaft 2. However, for example, circumferentially separated protrusions 71 and/or steps 77 may be used instead. Also, as the locking means 71 and 77, separate members such as snap rings may be attached onto the inner periphery of the housing 3 and the outer periphery of the second shaft 2, respectively, though this is troublesome as mentioned above.

Since, in the open end portion of the interior of the hearing tube 4, the first bearing snap ring 74 on the inner periphery of the bearing tube 4, and the second bearing snap ring 76 on the outer periphery of the second shaft 2 are used as means for restricting movement of the roiling hearing 60 in the direction from the other to the one axial end of the housing 3, the rolling bearing 60 can be easily locked in position in the open end portion of the interior of the bearing tube 4, which is relatively easily accessible.

The locking means 74, 76, 71 and 77 prevent axial movement of the rolling bearing 60 relative to the housing 3 and axial movement of the second, shaft 2 relative to the rolling bearing 60.

In the embodiment, as illustrated in FIG. 8, beveled snap rings 74a and 76a are used as the first and second snap rings 74 and 76, respectively. The snap rings 74a and 76a are, like ordinary snap rings, C-shaped (annular members, i.e., have one circumferentially separated portion. Additionally, the radially outer beveled snap ring 74a has, on its axial side surface, a tapered portion 74b inclined radially outwardly and toward the other axial end of the snap ring 74a, while the radially inner beveled snap ring 76a has, on its axial side surface, a tapered portion 76b inclined radially inwardly and toward the other axial end of the snap ring 76a.

The tapered portion 74b is in sliding contact with an inclined surface 72a of a groove 72 in the inner periphery of the bearing tube 4 such that the first bearing snap ring 74 is, radially expandable and compressible within the range of a radial gap W1. The tapered portion 76b is in sliding contact with an inclined surface 73a of a groove 73 in the outer periphery of the second shaft 2 such that the second bearing snap ring 76 is radially expandable and compressible within the range of a radial gap W2. Therefore, the first and second bearing snap rings 74 and 76 always press the respective end surfaces of the outer and, inner rings 61 and 62 of the rolling bearing 60 toward the one axial end, and thus reliably lock together the housing 3 and the rolling bearing 60, and the rolling bearing 60 and the second shaft 2.

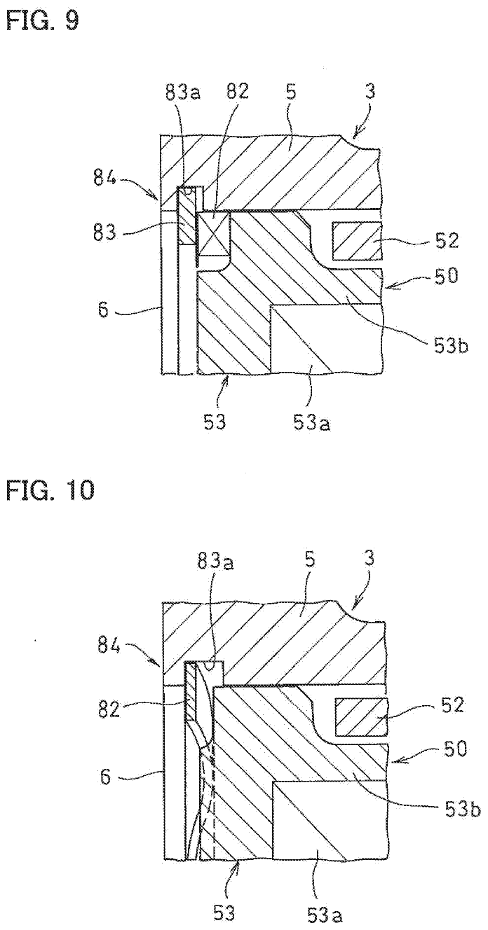

In the embodiment, as illustrated in FIGS. 1 and 9, the movement restricting means 84 is constituted by a movement restricting snap ring 83 disposed on the inner periphery of the housing 3 at the other axial end of the housing 3; and an elastic member 82 for movement restriction disposed between the snap ring 83 and the electromagnetic clutch 50, and biasing the electromagnetic clutch 50 in the direction from the other to the one axial end of the housing 3. The elastic member 82 may be selected from various kinds of spring members including a wave spring, a disk spring and a coil spring.

The elastic member 82 may be omitted, that is, the movement restricting means 84 may be constituted by only the snap ring 83 on the inner periphery of the other axial end of the housing 3. In this case, in order to restricts movement of the electromagnetic clutch 50 in the direction from the one to the other axial end of the housing 3, the snap ring 83 is pressed against the core 53b of the electromagnetic clutch 50.

Alternatively, the movement restricting means 84 may be, as illustrated in FIG. 10, constituted by an elastic member 82 for movement restriction engaging with the inner periphery of the housing 3 at the other axial end of the housing 3 and biasing the electromagnetic clutch 50 in the direction from the other to the one axial end of the housing 3. By using this elastic member 82, it is possible to eliminate the need to fix a separate member such as a snap ring to the housing 3. This elastic member 82 may be engaged with a groove 83a formed in the inner periphery of the housing 3, or a protrusion integrally formed on the inner periphery of the housing 3.

Because, as is apparent from the above description, the tolerance of the axial dimension of the rolling bearing 60 does not affect the axial height of the elastic member 82 when set in position, so that it is possible to, reduce variation in the magnitude of the load applied to the elastic member 82.

While in the embodiment, rotation is inputted to the first shaft 1, and outputted from the second shaft 2, rotation may be inputted to the second shaft 2 and outputted fro the first shaft 1.

In the embodiment, the two-way clutch 10 of the rotation transmission device is a roller-type clutch in which the control cage part 16A is axially moved by de-energizing the electromagnet 53 in the direction in which the control cage part 16A and the rotary cage part 16B rotate relative to each other such that the rollers 15 as engaging elements engage with the inner periphery of the outer member 11 and the outer periphery of the inner member 13. However, the two-way clutch 10 is not limited to such a clutch. For example, the two-way clutch 10 may be a sprag-type clutch in which a pair of cages different in diameter from each other are disposed radially inwardly and radially outwardly, respectively;
the cage disposed radially outwardly and thus having a larger diameter is constituted by a control cage part and a rotary cage part;
when the electromagnet of an electromagnetic clutch is de-energized, each opposed pair of sprags as engaging elements are engaged with a cylindrical inner peripheral surface of an outer member and a cylindrical outer peripheral surface of an inner member by an elastic member disposed between the opposed pair of sprags; and
when the electromagnet is energized, the control cage part and the rotary cage part rotate relative to each other so that the opposed pairs of sprigs are disengaged from the cylindrical surfaces.

### DESCRIPTION OF REFERENCE NUMERALS

1: first shaft

2: second shaft

3: housing

4: bearing tube

5: tubular portion

6: housing opening

10: two-way clutch

11: outer member

13: inner member

15: roller (engaging element)

16: cage

16A: control cage part

16B: rotary cage part

50: electromagnetic clutch

53: electromagnet

60: rolling bearing

74, 76, 71, 77: locking means

84: movement restricting means

1. A rotation transmission device comprising:
a housing;
a first shaft and a second shaft which are arranged coaxially with each other;
a two-way clutch received in the housing and configured such that the first shaft and a second shaft are selectively engaged with and disengaged from each other by the two-way clutch; and
an electromagnetic clutch received in the housing and including an electromagnet, the electromagnetic clutch being configured to selectively engage and disengage the two-way clutch by energizing and de-energizing the electromagnet;
wherein the two-way clutch comprises:
an inner member disposed on one of the first shaft and the second shaft;
an outer member disposed on the other of the first shaft and the second shaft;
engaging elements disposed between the inner member and the outer member; and
a cage retaining the engaging elements, and
wherein the rotation transmission device further comprises:
a rolling bearing disposed at a first axial end of the housing, and rotatably supporting the second shaft (2) and the housing (3);
locking arrangement that prevent relative axial movement between the second shaft and the rolling bearing, and between the rolling bearing and the housing; and
a movement restricting arrangement disposed at a second axial end of the housing which is opposite from the first axial end of the housing, and restricting movement of the electromagnetic clutch in a direction from the first to the second axial end of the housing.

2. The rotation transmission device according to claim 1, wherein the housing comprises:
a tubular portion in which the two-way clutch and the electromagnetic clutch are received; and
a bearing tube located between the first axial end of the housing and the tubular portion, and having a smaller diameter than the tubular portion,
wherein the rolling bearing is disposed in the bearing tube, and
wherein the locking arrangement include first locking arrangement and second locking arrangement, the first locking arrangement comprising:
a first bearing snap ring disposed on an inner periphery of the bearing tube so as to retain the one axial end of the rolling bearing which corresponds to the first axial end of the housing; and
a second bearing snap ring disposed on an outer periphery of the second shaft so as to retain the one axial end of the rolling bearing.

3. The rotation transmission device according to claim 2, wherein the second locking means arrangements comprise:
a protrusion disposed on the inner periphery of the bearing tube so as to retain a second axial end of the rolling bearing which corresponds to the second axial end of the housing; and
a step disposed on the outer periphery of the second shaft so as to retain the second axial end of the rolling bearing.

4. The rotation transmission device according to claim 1, wherein the movement restricting arrangement includes a movement restricting snap ring disposed on an inner periphery of the housing at the second axial end of the housing.

5. The rotation transmission device according to claim 1, wherein the movement restricting arrangement includes an elastic member for movement restriction engaged with an inner periphery of the housing at the second axial end of the housing, and biasing the electromagnetic clutch in a direction from the second to the first axial end of the housing.

6. The rotation transmission device according to claim 1, wherein the movement restricting arrangement includes:
a movement restricting snap ring disposed on an inner periphery of the housing at the second axial end of the housing; and
an elastic member for movement restriction disposed between the movement restricting snap ring and the electromagnetic clutch, and biasing the electromagnetic clutch in a direction from the second to the first axial end of the housing.
